(19) United States
(12) Patent Application Publication
(10) Pub. No.: US 2021/0103904 A1
(43) Pub. Date: Apr. 8, 2021

(54) METHOD AND SYSTEM FOR FRANKING POSTAL ARTICLES AND FOR BILLING A LOGISTICS SERVICE

(71) Applicant: Siemens Aktiengesellschaft, Muenchen (DE)

(72) Inventors: Thomas Bayer, Hirschaid (DE); Michael Bueker, Abu Dhabi (AE); Monika Sturm, Wien (AT); Michael Zettler, Allensbach (DE); Jan Dodel, Konstanz (DE); Holger Schmitt, Hessheim (DE)

(21) Appl. No.: 17/050,107

(22) PCT Filed: Feb. 21, 2019
(86) PCT No.: PCT/EP2019/054277

§ 371 Date: Oct. 23, 2020

(30) Foreign Application Priority Data
Apr. 23, 2018 (EP) 18168757.5

(51) Int. Cl. G06Q 20/14; G06Q 10/08; G06Q 20/08; G07B 17/00; G06K 1/12; G06K 19/06; G06Q 20/38; G06Q 20/36; G06Q 10/10; G06Q 50/26; G06Q 30/00

(52) U.S. Cl. CPC G06Q 20/14; G06Q 2220/00; G06Q 20/085; G07B 17/00733; G07B 17/00508; G07B 17/0008; G06K 1/121; G06K 19/06028; G06Q 20/389; G06Q 20/367; G06Q 10/10; G06Q 20/3827; G06Q 50/26; G06Q 30/0185; G06Q 2250/70; G06Q 2250/80; G07B 2017/0083; G07B 2017/00588; G07B 2017/0062; G07B 2017/00169; G06Q 2250/60; G06Q 10/083

(57) ABSTRACT

In order to prevent stamps or indicia from being forged and in order to bill a logistics service between different postal service providers correctly to the user, a computer-implemented method for franking postal articles is implemented. The article's progress is recorded by readers and, together with the accompanying franking identification, is stored in blocks of a blockchain as a transaction. In doing so, the assignment of the readers to a postal service provider is recorded. The logistics service provided is billed correctly to the user by analyzing the transactions stored in the blockchain that are to be allocated to at least one postal service provider.

The present invention relates to a method for franking postal articles and for billing a logistics service according to claim 1 and a system for billing a logistics service between postal service providers.

At present, franking of postal articles and services and charges is substantially based on:

a) franking by means of prepaid postage stamps,

b) franking by means of postage meters plus a barcode and postage-meter identity, prepaid or by means of billing based on a meter (franking machine),

c) franking by means of printed barcodes and subsequent payment and/or weighing for volume-based and/or weight-based billing.

Past and present evidence shows that this procedure may be subject to fraudulent activity as a result of the lack of verifiability of the franking in that

a) stamps are forged,

b) posting meter barcodes are used multiple times and

c) barcodes are copied.

For postal service providers, this results in significant losses and/or high investments, for example in the field of the design and the detection of forgery-proof postage stamps or forgery-proof stamps or indicia.

Regardless of the form, postal stamp, barcode etc., hereinafter, the following technology-neutral terms will be used—postal stamps or indicia or just stamps or indicia. Hereinafter, letters, large letters, bulk mail or parcels will be subsumed under the synonyms “postal articles” or “postal article units” in the singular or plural depending on the consideration.

If, for example, postal articles are conveyed from Germany to the USA, the sending postal service provider (in this case, for example, DP DHL) can pay the receiving postal service provider a fee in advance (in this case, for example, United States Postal Service USPS https://www.usps.com), because the receiving postal service provider provides a part of the service, namely the acceptance of the postal article and its delivery to a recipient.

Instead of a fixed advance fee, the remuneration between the postal service providers can also be made subsequently—to be precise in a “post processing” process. For this purpose, the IPC (International Postal Corporation https://www.ipc.be/ensures that the financial compensation between the postal service providers involved is as equitable as possible.

For this purpose, the IPC measures the flow of letters and packets (number, transit time) between the countries including the postal service providers involved and their service quality. If a country or a postal service provider has unsatisfactory, i.e. excessively long, transit times, a penalty charge is factored in. In addition, in each participating country, there are people, who make, send and receive postal articles on a random basis and enter the data on the postal articles (type of postal articles, posting location, posting time, delivery location, delivery time) into an IPC IT system. The entire process is time-consuming, and hence expensive, and its accuracy questionable due to small random samples.

Therefore, the present invention is based on the object of disclosing a forgery-proof method and a system for franking postal articles and for billing the corresponding logistics service correctly to the user, which remedy the aforementioned deficiencies and can easily be implemented in the existing mail handling system.

This object is achieved by the computer-implemented method disclosed in claim 1 and by the system disclosed in claim 12. Advantageous embodiments of the invention are disclosed in further claims.

The computer-implemented method according to the invention for franking postal articles and for billing a logistics service between postal service providers has the following method steps:
application of a stamp or indicium (W) with a machine-readable and unique franking identification (W-Id) to a postal article to be conveyed (S),
conveyance of the postal article (S) from a sender (1) and delivery to a recipient (23) by postal service providers (P; P₁, P₂) as a logistics service;
the franking identification (F-Id) is stored in a block (Ni) of a blockchain (B);
the franking identification (W-Id) of the stamp or indicium (W) applied to the postal article (S) to be conveyed is recorded in a system (10, 11) of a first postal service provider (P₁) by a reader (R);
the recorded franking identification (W-Id) is compared with the franking identification (F-Id) stored in the relevant block (Nᵢ) of the blockchain (B);
if it is established that they are identical, the franking identification (F-Id) is deemed to be “active” and stored as active as a transaction in a block (Ni) of the blockchain (B);
during the further conveyance of the postal article (S) by systems (10, 11, 20, 21, 22) of the postal service providers (P₁, P₂), the franking identification (W-Id) applied to the postal article (S) is recorded by readers (R) allocated to the respective system (10, 11, 20, 21, 22) and stored as a transaction together with the identity of the system (10, 11, 20, 21, 22) including the identity of the relevant postal service provider (P₁, P₂) and a time stamp of the recording in a block (N_{i′}) of the blockchain (B);
the logistics service is billed by analyzing the transactions stored in the blockchain (B) that are to be allocated to at least one postal service provider (P₁, P₂).

Thus, the following additional advantages can result:

i) copy protection for stamps or indicia is ensured in that, on the first recording of such a stamp or indicium, its franking identity is stored in the blockchain. If the same identity of a stamp or indicium is later registered again “first recording”, this can be established on the basis of the secured filing of the franking identity in a block of the blockchain and the corresponding postal article can be sorted out.

ii) Copy protection for stamps or indicia can be further ensured if the transmission of the franking identity is encrypted end-to-end.

iii) The first recording of the identity of a stamp or indicium preferably takes place during the outgoing sorting. A further recording location is provided when the postal article is handed over at a post office counter. Since such postal articles later are also “first recorded” during the outgoing sorting, it is necessary to ensure that such postal articles are not rejected as “copied” due to a franking identity that has already been activated. Such a non-rejection is achieved by the identity of the recording device—also called a reading device or reader—and by a plausibility check on the time stamp during the recording.

iv) The billing of the logistics service between the postal service providers involved can be performed automatically. Since the sending postal service provider may have entered into an obligation toward its customer regarding the length of time until a delivery is made, the secured filing of the data on the progress of a postal article to the recipient permits any repayment owed to the sender to be passed on in accordance with the causative principle to the postal service provider who is ultimately responsible for a delay.

vi) Trustworthy and resilient billing of the logistics service between the postal service providers involved preferably takes place with a smart contract with an executable code that is also filed in at least one block of the blockchain.

vii) While with conventional stamps or indicia, the (monetary) value is determined at the start when the postal article is handed over, the present invention also permits billing for the attention of the postal user even after the delivery of a postal article in a so-called debit procedure. Since the other data on the progress of the shipment of each postal article is also stored in the blockchain, the billing can also include any possible reduction (penalty charge) after a late delivery, wherein the correct time of deliveries is defined in a service-level agreement. This service-level agreement can be contained in a further smart contract as an executable code.

The invention is described in the following by way of example with reference to the drawing, which shows:

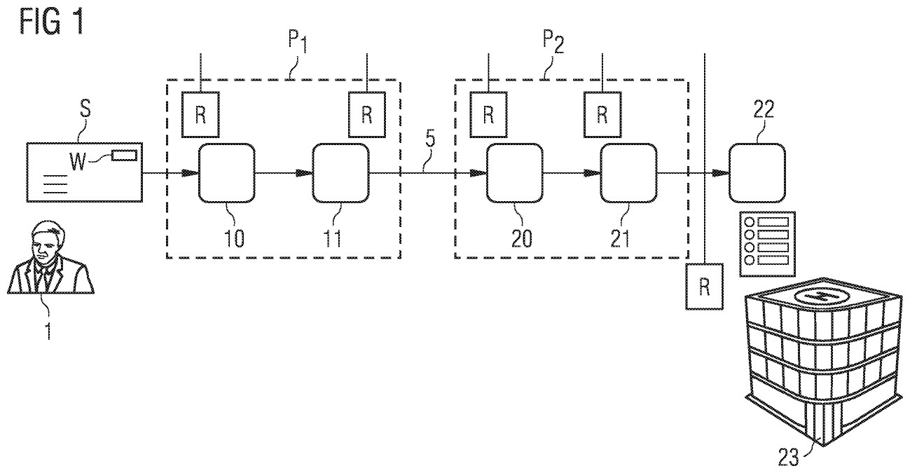

FIG. 1 the progress of a postal article S until delivery 22 to the recipient 23;

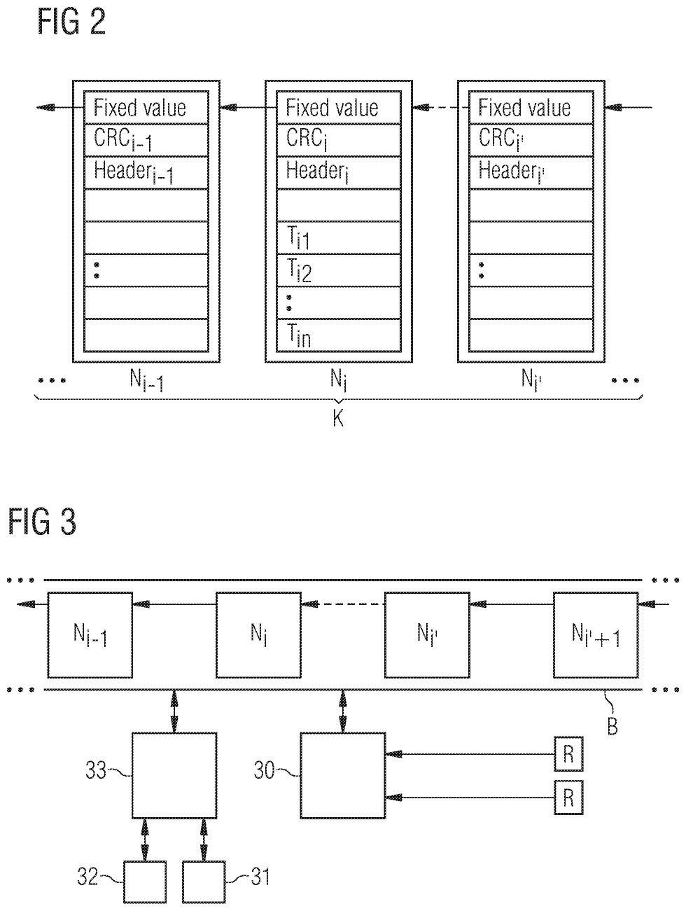

FIG. 2 the structure of the contents of blocks of a blockchain;

FIG. 3 a schematic depiction of access to a blockchain B and the data consumers and data producers.

FIG. 1 shows the progress of a postal article S handed over by a sender 1. In this case, it is assumed that a postal article S is accepted by a first postal service provider P₁—also called the “sending” postal service provider—in one country A and then conveyed 5 to a second postal service provider P₂— also called the “receiving” postal service provider—in a country B until it is delivered 22 to a recipient 23. This depiction in FIG. 1 is also applicable to a domestic delivery; only the first postal service provider P₁ and the second postal service provider P₂ in FIG. 1 should be considered to be identical. The invention can also be carried out according to the following case, not depicted in FIG. 1: three different postal service providers can also be involved in the conveyance of a postal article; herein, the “middle” postal service provider deals with the “long-distance transportation” of the postal articles. In such a case, it is only necessary for the parameters to be suitably adapted during the recording of the postal articles S by readers R.

The progress of a postal article S depicted in FIG. 1 includes the possibility that postal articles S are also handed over to a postal service provider P for conveyance via both mail boxes or mail rooms. The postal article S is collected—depicted by the unit 10—and then undergoes outgoing sorting 11.

The postal articles S sorted in this way are transported in accordance with the so-called shipment direction, be it by land, air or sea. The postal articles S are sorted in an entry sorting 20 in accordance with the delivery bases 21. Delivery 22 to the recipients 23 takes place from the delivery bases 21.

Franking identities are required for the franking of the postal articles S in accordance with the quantity of postal articles to be conveyed.

A body authorized by a postal service provider P or by a postal surveillance authority generates unique franking identities F-Idᵢ corresponds to a power corresponding to the need of the relevant postal service provider P for a certain period, for example a month. This can typically entail several million postal articles S a day. In Germany, the Federal Printing Office could be designated as the authorized body, for example. In the context of this description, the authorized body is called the “franking identity issuer 32”. The following now refers to FIG. 3. This multiplicity of franking identities F-Idᵢ is secured via a wallet 33 filed in nodes Nᵢ, Nᵢ₊₁, etc., of a blockchain B. The term block is used synonymously instead of the term node. For the sequence of franking identities F-Idⱼ, j is an index for numbering the franking identities F-Id or F-Idⱼ.

First, the process of franking the postal articles S is described. This requires stamps or indicia W. Depending upon the sender 1, the sequence of the franking identities F-Idᵢ introduced above is applied as follows on stamps or indicia W for the franking of postal articles S:

I Franking Individual Postal Articles

Individual postal articles S require stamps or indicia W that are comparable to postage stamps: a stamp or indicium printer 31 (not to be confused with the aforementioned Federal Printing Office) obtains a range of franking identities F-Idᵢ, -, F-Id_{I} from a node Nₖ via a wallet 33.

In the above, I stands for a certain number of such franking identities. When these franking identities F-Idᵢ are obtained, the aforementioned range of franking identities F-Id₁, -, F-Id_{I} are marked as “used” in the blockchain B. The stamp or indicium printer produces unique stamps or indicia W from such a range of franking identities F-Id₁, -, F-Id_{I} (unique in the sense of injective), which are for example printed as a QR code [1]. The above-described process of obtaining these franking identities F-Idᵢ can be additionally secured as follows:

If one of the senders 1 wishes to buy stamps or indicia W, the sender receives a sequence of valid, but encrypted, franking identities vF-Idᵢ. These are encrypted with a key, namely on the generation of the franking identities F-Idᵢ by the authorized body 32. An encrypted digital equivalent is printed on the letter or the parcel—preferably as a QR code [1].

Alternatively to the production of a multiplicity of stamps or indicia W, it is also possible for a customer to purchase a stamp or indicium W individually via online access via the postal service provider P which the customer can print out at home and apply to an individual postal article S. The stamp or indicium W is preferably embodied as a QR code [1]. The process is similar to that described above according to which a franking identity F-Id obtained in this way is marked as “used” in the blockchain B. Herein, the customer does not access the blockchain B directly, but accesses an application of the postal service provider that permits access to a franking identity F-Id via a wallet 33 of the blockchain B. The stamp or indicium W generated in this way contains a franking identity W-Id that corresponds to the franking identity F-Id stored in the blockchain.

II Postage Meter Facilities

So-called postage meters are used for companies with a considerable volume of postal articles S to be shipped. With respect to one embodiment of the present invention, such postage meter facilities can be connected to the above-mentioned blockchain B via a wallet 33 online via an application of the relevant postal service provider. According to the required number of franking identities, franking identities F-Id₁, -, F-Id_{I} are transferred to the postage meter facility which applies these franking identities to the postal articles S or stamps them on in encoded form, once again preferably as a QR code [1]. Herein, as mentioned above, the transferred ranged is marked as “used” in the blockchain. The stamp or indicium W stamped on contains a franking identity W-Id that corresponds to the franking identity F-Id.

III Major Distributors

Major distributors differ from customers with postage meter facilities in a particularly high volume of postal articles S to be delivered and in preliminary services such as, for example, presorting of the postal articles S. The procedures for franking such high volumes of postal articles do not actually differ from the procedures with postage meters and will not be described again here.

The above-described process for individual postal articles S, postage meter facilities and major distributors is not depicted in FIG. 1. FIG. 1 only depicts the result, namely a postal article S with a stamp or indicium W symbolically. The postal articles S are collected or “handed over” by a sender 1 at a post office counter (not depicted in FIG. 1). The stamps or indicia W applied to the postal articles S are recorded by a reader R either at the post office counter or during the immediately following outgoing sorting 10. At the same time or beforehand, further parameters of the postal articles S can be recorded such as, for example, the weight or dimensions of the postal articles S (for example large letter) or the destination of the postal articles S. At least the recorded franking identity W-Idₖ is transferred by the readers R via an oracle to the blockchain B and the corresponding franking identity F-Idⱼ is marked as “active” in the blockchain B. This marking as “active” includes the following checks in advance:

a) is the relevant franking identity F-Id marked as “used”? If not, should the accompanying stamp or indicium W be considered to be invalid since the stamp or indicium W was not generated in accordance with the defined process sequence and the relevant postal article S has to be removed from the flow of postal articles.

b) Has the relevant franking identity F-Idⱼ already been marked as “active”? If YES, the relevant stamp or indicium should be considered to be an (illegal) duplicate and the relevant postal article S has to be removed from the flow of postal articles. Due to the automation already implemented at postal service providers, the above-described removal of such postal articles S with an invalid stamp or indicium W takes place by means of a temporarily generated virtual destination “invalid stamp or indicium” during the sorting process. An oracle 30 is a hardware interface between the infrastructure (here the infrastructure of the postal service providers P) and a blockchain B. The aforementioned checking includes the fact that the read franking identities W-Idₖ are transmitted in encrypted form and encrypted by a key stored in a node where they are checked in encrypted form. In addition to the franking identity W-Idₖ, it is possible for further values/parameters associated with this franking identity W-Idk to be stored such as, for example:
the time stamp of the recording by the reader R,
the reader identity R-Id of the reader R,
the identity of the location and/or
the identity of the postal service provider P₁.

The above-mentioned check on the validity of a recorded franking identity is preferably executed with an executable program code, which is in turn stored in at least one node Nᵢ of the blockchain B. This program code is preferably executed by the infrastructure of the distributed database system (blockchain). The execution environment and the program code are ideally Turing-complete [2].

In the further stages of the conveyance of the postal articles, for example, entry sorting 20, transportation 5 or delivery base 21, further readers R can be provided, which, in a similar manner to that described above, record the franking identity W-Idₖ with further accompanying values/parameters—as explained above—and forward it for storage.

During the last sorting before delivery 22, due to a parameter “last handling”, the recording of the franking identity W-Id by a reader R causes the following special entry: the franking identity W-Idₖ and further values such as, for example, the identity R-Id of the reader R and “last handling” transmitted during this last sorting before delivery 22 cause the franking identity F-Idₖ to be marked as “cancelled”. Saving the above-mentioned information in a node Ni of the blockchain B may only take place after buffering outside the blockchain B in order to reduce performance problems.

Hence, the following information is available in the blockchain B for a franking identity F-Idᵢ marked as “cancelled”:
progress of the postal articles S associated with the franking identity F-Idi with time stamps, locations and associated postal service providers P;
properties of the postal article S such as destination, dimensions and weight.

The aforementioned information forms the basis of the billing between the postal service providers P1, P2, etc. involved correctly to the user. This billing is preferably performed by a so-called smart contract. A smart contract is stored as a transaction in at least one node Ni. This transaction is in the form of executable program code with the same conditions as described above for checking the recorded franking identities W-Idₖ. During the correct billing to the user, only the franking identities stored in transactions entered as “used” are taken into account. The result of this billing is filed in wallets allocated to the postal service providers P1, P2, etc.

Hence, the franking identities F-Id, F-Idᵢ stored in a node Nₖ of a blockchain B can have the following markings:
“new”

on the filing of the franking identities F-Id, F-Idᵢ generated by the authorized body 32;
“active”

when a franking identity F-Id is obtained in order to apply it on a stamp or indicium provided for a postal article S;
“used”

on the first recording of the postal article S;
“cancelled”

before delivery to the recipient 23.

If only one postal service provider P is involved, the data obtained during the billing of the logistics service is used for inter-group correct billing to the user for each PC (profit center) or each region.

Reference is made once again to the fact that the above-described entries in nodes Nᵢ of a blockchain B should not be understood to mean that a node Nᵢ in a blockchain B is generated for each recorded postal article S. The respective recordings of the franking identity W-Idₖ (derived as described above from the franking identity F-Idₖ) are combined and, for example, entered into a node Nᵢ for each time interval of 10 min or each recording location of a postal service provider P in a node Ni. The franking identities W-Idₖ recorded by the readers R are buffered “off-chain” and filed in a defined number for each time interval in a node Nᵢ of the blockchain B.

The present invention is also suitable for “lettres recommandées”/registered letters with or without an acknowledgement of receipt. For evidence, registered letters have to be handed over specially, be it with an accompanying document or to a post office counter by issuing a so-called receipt. Most postal service providers P also include insurance with registered letters that pays a minimum financial compensation on the loss of such a postal article S (not to be confused with so-called postal articles of value). If a registered letter is now handed over to a postal service provider P, a further parameter for the franking identity W-Idₖ is filed. This parameter causes these letters to be conveyed separately from the other letters during the further conveyance and recorded accordingly at “neuralgic” points. Here, “neuralgic” means: points where there is an increased risk of errors or loss. The handling of the postal articles is determined by the franking identity W-Idₖ, to be precise: the further stored values for the relevant franking identity W-Idₖ are filed. These values (also called parameters) determine the further handling of a postal article S. On the delivery 22 of a registered postal article S to a recipient 23, the recipient 23 acknowledges receipt in the usual method by a signature on a device. This device should be classed as being the same as a reader R. The information transmitted and the parameters filed on the relevant franking identity W-Idₖ for the treatment of such a postal article S cause a reverse acknowledgement of receipt to be sent back to the sender 1 of such a postal article S. Hence, this also means that, for validation, registered postal articles must identify a sender 1, and to be precise as a physical person, on the postal article and in the additional values (also parameters) on the first recording. The coordinates or address of the sender 1 are also initially stored on the registration of a franking identity W-Idₖ.

Similarly, on the handing over or the first recording of a postal article S, its weight, dimensions and destination are recorded. These values are in turn allocated to a franking identity W-Idₖ, but the actual values/parameters are stored in a node Nₖ of a blockchain B as a transaction for the accompanying franking identity W-Idₖ, wherein, as stated above, this storage in a node Ni of the blockchain B does not have to be performed in real time. The above-explained values/parameters are to be recorded as transactions in exactly the same way as merely the recording of a postal article S at any point in the postal article's progress by a reader R.

FIG. 3 shows in a simplified view the functional and static components involved in the suggested computer-implemented method. The blockchain B is implemented as a distributed database system with which the individual blocks Ni are interlinked by pointers. Here, distributed in particular means that the individual blocks Ni, Nᵢ₊₁ etc. do not have any specific geographic allocation or allocation to a specific server. The integrity of the blocks Nᵢ is filed by a hash value—(also in the relevant block Nᵢ). Access to the storage in the blocks Nᵢ, N_{i′}, etc. takes place via a so-called oracle 30. The different readers R in the systems 10, 11, 20, etc. of the postal service providers P₁, P₂ are connected to the oracle 30. In a specific embodiment of the present invention, the values recorded by the readers R are combined and buffered together with the recorded franking identities in data buffers or in servers and transmitted in a corresponding multiplicity to the oracle 30 for filing in a block Nᵢ of the blockchain B.

A set of rules for the billing of the logistics service on the basis of the transactions which are stored in the blockchain B and to be allocated to the individual postal service providers P, P₁, P₂ is provided as a smart contract. The billing values can be filed in a so-called wallet 33 from where the further invoicing in accordance with known methods takes place in cash or in a digital means of payment. Herein, a wallet 33 is provided for each postal service provider P, P₁, P₂ (not depicted in the figures).

FIG. 2 shows the basic structure of the nodes Ni of a blockchain. CRC designates a hash value for all the nodes Nᵢ to ensure the authenticity of the relevant node. The headerᵢ establishes the structure and size of the relevant node Nᵢ. The transactions Ti₁, Ti₂, contain a plurality of franking identities F-Id and optionally additional data recorded during the postal article's progress as described above. I.e. data, which is acquired via the readers R. Also contained as a transaction is executable program code, which, for example, form a smart contract or is used for checking the franking identities W-Id recorded by the readers R. This program code can run in blockchain middleware or in middleware outside of the relevant blockchain B. For reasons of performance, an implementation is also possible with which the values recorded by the readers values are not filed directly, but only via their hash values.

The exemplary embodiment described here does not restrict the present invention. Depending upon the legal or organizational framework conditions for postal service providers, the readers R for recording of the franking identity W-Id can also be arranged differently in the mail processing process and the recorded data for the postal articles S such as destination, weight, dimensions, allocation to the systems does not need to be embodied as described above. Other combinations of data, readers and the filing in nodes Nᵢ of a blockchain B can be made by the person skilled in the art without departing from the scope of protection of the invention.

### LIST OF REFERENCE CHARACTERS, GLOSSARY

B Blockchain
F-Id, F-Idᵢ Franking identity
vF-Id, vF-Idᵢ Encrypted franking identity
R-Id, R-Idⱼ Identity of a reading device
W-Id, W-Idₖ Franking identity on a stamp or indicium W
N; Nᵢ Node of a blockchain, block of a blockchain
P; P₁, P₂ Postal service provider
R; R₁ Reading device, readers
S Postal articles
W; Wₖ Stamp or indicium
i, j, k, 1 Indices from the set of values No
1 Sender
5 Transport by land, air, sea
10 Mail collection
11 Outgoing sorting
20 Entry sorting
21 Delivery base
22 Delivery
23 Recipient
30 Oracle
31 Stamp or indicium printer, stamp or indicium manufacturer, postage meter
32 Authorized body, franking identity issuer
33 Wallet

### SOURCES, LITERATURE

[1] QR code https://de.wikipedia.org/wiki/QR-Code visited on 25 Mar. 2018
[1] Turing-completeness https://de.wikipedia.org/wiki/Turing-Vollständigkeit visited on 28 Mar. 2018

1-12. (canceled)

13. A computer-implemented method for franking postal articles and for billing alogistics service between postal service providers, which comprises the method steps:
applying a stamp or indicium with a machine-readable and unique franking identification to a postal article to be conveyed;
storing the franking identification in a block of a blockchain;
recording the franking identification of the stamp or indicium applied to the postal article to be conveyed in a system of a first postal service provider by a reader;
comparing a recorded franking identification with the franking identification stored in the block of the blockchain;
deeming the franking identification to be active and stored as a transaction in a further block of the blockchain as “active” if it is established that the recorded franking identification is identical to the franking identification stored in the block of the blockchain;
conveying the postal article from a sender and delivery to a recipient by the postal service providers as a logistics service;
during a conveyance of the postal article by systems of the postal service providers, the franking identification applied to the postal article is recorded by readers allocated to the system and stored as a transaction together with an identity of the system including an identity of the postal service providers and a time stamp of a recording in the block of the blockchain; and
billing the logistics service by analyzing transactions stored in the blockchain that are to be allocated to at least one of the postal service providers.

14. The method according to claim 13, wherein a first time the franking identification is recorded, the franking identification stored in the block of the blockchain is marked as “used”.

15. The method according to claim 13, wherein before delivery to the recipient, the franking identification applied to the postal article is recorded and a corresponding franking identification stored in the block of the blockchain is marked as “cancelled”.

16. The method according to claim 15, wherein the billing of the logistics service is based on the transactions stored in the blockchain that are to be allocated to a postal service provider which have the “cancelled” marking.

17. The method according to claim 14, wherein when the first time the franking identification of the postal article is recorded, an additional parameter meaning “registered letter” and an address of the sender is filed as a transaction in the block of the blockchain.

18. The method according to claim 17, wherein a reception of the postal articles by the recipient is acknowledged via a device and this prompts a corresponding entry relating to a relevant franking identification in the blockchain which prompts the transmission of an acknowledge of receipt to the sender.

19. The method according to claim 13, wherein a first time the franking identification of the postal article is recorded, a check is performed as to whether the franking identification stored in the blockchain is already marked as “active” and, if so, an ejection transfer of the postal article is prompted.

20. The method according to claim 13, which further comprises generating franking identities by a body authorized by a postal service provider and, via a wallet, stored in blocks for a first time.

21. The method according to claim 13, wherein the billing of the logistics service takes place by means of a smart contract, wherein the smart contract is stored as executable program code in a block and an analysis is based on the transactions stored in the blockchain that are to be allocated to the at least one postal service provider.

22. The method according to claim 21, which further comprises storing billing data in a wallet allocated to the postal service provider and the billing between the postal service providers takes place with a digital means of payment.

23. The method according to claim 13, which further comprises storing hash values of parameters recorded by the readers in blocks of the blockchain as transactions.

24. A system for billing a logistics service between postal service providers, the systems comprising:
means for executing a method according to claim 13.
